(19) United States
(12) Patent Application Publication
(10) Pub. No.: US 2006/0174284 A1
(43) Pub. Date: Aug. 3, 2006

(54) Apparatus and Method for Outputting Multimedia

(75) Inventor: Jae-Ho NA, Seocho-Gu, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/275,799

(22) Filed: Jan. 30, 2006

(30) Foreign Application Priority Data
Feb. 1, 2005 (KR) 1020050009238

(51) Int. Cl. H04N 7/18

(52) U.S. Cl. 725/75

(57) ABSTRACT

An apparatus for outputting multimedia from a telematics terminal within a vehicle includes a selection device for selecting a first multimedia signal and a second multimedia signal from at least one multimedia source. The apparatus includes a first display unit for displaying an image based upon the first multimedia signal and a second display unit for displaying an image based upon the second multimedia signal.

### CROSS-REFERENCE TO RELATED APPLICATIONS

This application claims priority under 35 U.S.C. § 119 to Korean Patent Application No. 2005-0009238, filed in Korea on Feb. 1, 2005, the entirety of which is incorporated by reference herein.

### BACKGROUND

This description relates to outputting multimedia from a telematics terminal.

A telematics terminal will be described in greater detail with reference to FIGS. 1 and 2. FIG. 1 shows a conventional telematics terminal 100 mounted in a car, and FIG. 2 is a schematic block diagram showing a conventional telematics system.

Referring to FIG. 2, the telematics system includes an information providing center 300 for providing telematics service information such as a call function, map information, traffic information and/or multimedia information. The system includes a telematics terminal 100 for receiving the telematics service information through a wireless communication network 200 and for providing the received telematics service information to users.

The telematics terminal outputs a TV broadcast signal or an audio/video signal recorded in a CD (Compact Disk)/DVD (Digital Versatile Disk) through a single monitor. For example, when the TV broadcast signal is selected by a driver of a vehicle, a passenger in the back seat in the vehicle watches the TV broadcast signal which has been selected by the driver.

### SUMMARY

In one general aspect, an apparatus for outputting a signal from a telematics terminal inside a vehicle includes the telematics terminal located inside of the vehicle and configured for outputting a plurality of audio and video signals. The apparatus includes a selection device configured for receiving audio and video signals outputted from the telematics terminal, and for selecting, from among the received audio and video signals, a first video signal, a first audio signal in synchronization with the first video signal, a second video signal and a second audio signal in synchronization with the second video signal. The apparatus includes a first multimedia output unit operatively connected with the telematics terminal at a front surface of the telematics terminal, the first multimedia output unit being configured for displaying the first video signal, and a second multimedia output unit operatively connected with the telematics terminal, the second multimedia output unit being configured for outputting the second video signal. The apparatus includes a speaker for outputting the at least one first or the second audio signal.

Implementations of this aspect may include one or more of the following features.

The apparatus may include a connection for a multimedia device operatively connected to the second multimedia output device, wherein the connection to the multimedia device provides a port for interactive control of the second multimedia output device.

In another general aspect, an apparatus for outputting multimedia from a telematics terminal includes the telematics terminal and a selection device operatively connected to the telematics terminal for selecting a first multimedia signal and a second multimedia signal from at least one multimedia source. The apparatus includes a first display unit for displaying an image based upon the first multimedia signal and a second display unit for displaying a separate image based upon the second multimedia signal.

Implementations of this aspect may include one or more of the following features.

The first and second multimedia signals may each include audio and video signals.

The first and second display units may each include a speaker. The first and second display units comprise liquid crystal displays.

The at least one multimedia source may be selected from the group consisting of an optical media processing unit, a TV tuner, a memory processing unit and an external signal processing unit. The optical media processing unit may include a CD/DVD processing unit for multimedia data recorded in a CD (Compact Disk) or a DVD (Digital Versatile Disk). The TV tuner may be configured for processing a TV broadcast signal from a channel selected by a user. The memory processing unit may be configured for processing multimedia data stored in a storage media. The external signal processing unit may be configured for processing multimedia data inputted to the selection device through an external line.

In another general aspect, an apparatus for outputting multimedia includes a telematics terminal within a vehicle and a selection device for selecting first and second video signals from at least one multimedia source. The apparatus includes a first display unit operatively connected with the telematics terminal at a front surface of the telematics terminal for displaying an image based upon the first video signal, and a second display unit operatively connected with the telematics terminal for displaying an image based upon the second video signal.

Implementations of this aspect may include one or more of the following features.

The selection device may be configured for selecting a first audio signal synchronized with the first video signal and a second audio signal synchronized with the second video signal.

The first display unit may include a first speaker for outputting the first audio signal and the second display unit includes a second speaker for outputting the second audio signal.

The first and second display units comprise liquid crystal displays.

An apparatus for outputting multimedia from a telematics terminal inside a vehicle includes the telematics terminal inside vehicle, and a selection device operatively connected with the telematics terminal, the selection device being configured for selecting a first dataset and a second dataset among multimedia data from an available storage media. The apparatus includes a first display unit within the vehicle for displaying the first dataset, and a second display unit within the vehicle for displaying the second dataset.

Implementations of this aspect may include one or more of the following features.

The available storage media may be selected from the group consisting of an optical media, data from a broadcasted channel selected by the user, multimedia data stored in a memory device and multimedia data communicated to the telematics terminal from an external location.

The selection device may include a first switching unit for selecting the first dataset and outputting the selected first dataset to the first display unit, and a second switching unit for selecting the second dataset and outputting the selected second dataset to the second display unit.

In another general aspect, a method for outputting multimedia includes selecting a first multimedia signal and a second multimedia signal from at least one multimedia source, and displaying an image based upon the first multimedia signal on a first display unit. The method includes displaying an image based upon the second multimedia signal on a second display unit.

Implementations of this aspect may include one or more of the following features.

The first and the second multimedia signals may each include audio and video signals.

The first and second multimedia signals may be selected from the group consisting of multimedia data recorded in an optical media, a TV broadcast signal of a channel selected by a user, multimedia data stored in a memory device, and multimedia data communicated from an external source.

The first and second display units may include liquid crystal displays.

In another general aspect, a method for outputting multimedia from a telematics terminal within a vehicle includes selecting first data and second data, wherein the first data and the second data are each selected from the group consisting of multimedia data recorded in an optical media and selected by a user, TV broadcast data from a channel selected by the user, multimedia data stored in a memory and multimedia data communicated from an external source. The method includes displaying the first data on a first display unit operatively connected to the telematics terminal, and displaying second data on a second display unit operatively connected to the telematics terminal.

Implementations of this aspect may include one or more of the following features.

The first display unit may be installed at a front surface of the telematics terminal and the second display unit may be installed at a predetermined position, such as at a rear of the vehicle, inside the vehicle.

The method may include inputting a multimedia signal to the second display unit from a multimedia device operatively connected to the second display unit.

The foregoing and other objects, features, aspects and advantages will become more apparent from the following detailed description when taken in conjunction with the accompanying drawings.

### BRIEF DESCRIPTION OF THE DRAWINGS

FIG. 1 is a view of a telematics terminal mounted in a vehicle.

FIG. 2 is a schematic block diagram of a conventional telematics system.

FIG. 3 is a schematic block diagram of an apparatus for outputting multimedia from a telematics terminal.

FIG. 4 is a detailed block diagram of a selector of the multimedia outputting apparatus.

FIG. 5 is a flow chart of a process for outputting audio/video signal(s) from the telematics terminal.

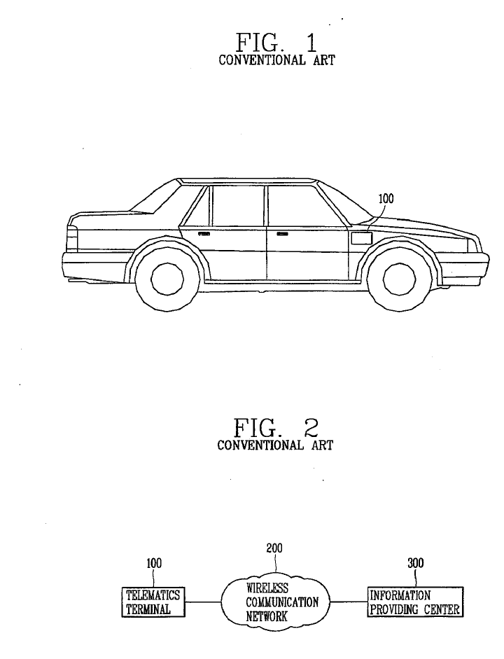

### DETAILED DESCRIPTION

An apparatus and method for outputting multimedia capable of allowing respective passengers seated in the front seat and back seat in a vehicle to watch individually selected content, e.g., permits respective passengers to watch the same or different multimedia by outputting a first multimedia signal, such as first audio/video signal, of a telematics terminal on a first display unit inside a vehicle and outputting a second multimedia signal, such as a second audio/video signal, of the telematics terminal on a second display unit inside the vehicle.

In general, a telematics terminal within a vehicle, such as a car or other passenger vehicle, is connected with a wireless communication network. The telematics terminal provides a call function, map information, a multimedia function and/or a GPS (Global Positioning System) navigation function. The telematics terminal also may include an audio and video system, interactive gaming stations, and/or other multimedia modules.

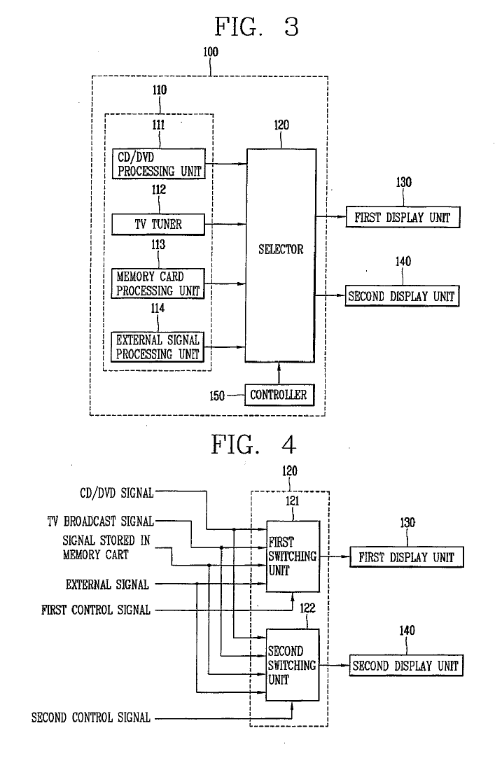

FIG. 3 is a schematic block diagram of an apparatus for outputting multimedia from a telematics terminal. Referring to FIG. 3, an apparatus for outputting multimedia of a telematics terminal 100 includes a multimedia signal processor 110 for processing various multimedia signals and a selector 120 for selecting first and second multimedia signals among the multimedia signals according to a user selection and for outputting the selected first and second multimedia signals. The apparatus includes a first display unit 130 and a second display unit 140. The first display unit is installed at a front surface of the telematics terminal 100 and displays the first multimedia signal. The second display unit 140 is installed at a predetermined position, e.g., a rear side of a front seat or other portion of a rear seat, inside the vehicle and displays the second multimedia signal.

The first display unit 130 includes a speaker (not shown) for outputting an audio signal contained in the first multimedia signal. The second display unit 140 includes a speaker (not shown) for outputting an audio signal contained in the second multimedia signal.

The multimedia signal processor 110 includes a multimedia processing unit, e.g., a CD/DVD processing unit 111 for processing/outputting multimedia data such as an audio/video signal recorded in a CD (Compact Disk), a DVD (Digital Video Disk or Digital Versatile Disk) or other storage media. The multimedia signal processor 110 also includes a TV tuner 112 for processing/outputting a TV broadcast signal of a channel selected by a user, a memory card processing unit 113 for processing/outputting multimedia data, e.g., an audio/video signal, stored in a memory card or other portable memory media, and an external signal processing unit 114 for processing/outputting multimedia data, e.g., an audio/video signal, inputted through an external line or communication link.

The selector 120 receives first and second control signals for selecting multimedia signals determined by the user from a controller 150, and selects the first and second multimedia signals based on the received first and second control signals. The first multimedia signal can be a multimedia signal outputted from a multimedia player, such as a CD/DVD processing unit 111, a TV broadcast signal outputted from the TV tuner 112, a multimedia signal outputted from the memory card processing unit 113, and a multimedia signal outputted from the external signal processing unit 114. The second multimedia signal can also be a multimedia signal outputted from the CD/DVD processing unit 111, a TV broadcast signal outputted from the TV tuner 112, a multimedia signal outputted from the memory card processing unit 113, and a multimedia signal outputted from the external signal processing unit 114. The first and the second multimedia signals can be outputted from the same device or different devices.

FIG. 4 is a detailed block diagram of the selector 120 of the multimedia outputting apparatus. The selector 120 can be changed to have various constructions based on FIG. 4. Referring to FIG. 4, the selector 120 of the audio/video outputting apparatus includes a first switching unit 121 and a second switching unit 122. The first switching unit 121 is provided for selecting a first multimedia signal among the multimedia signals outputted from the multimedia sources 111 to 114 and based on the first control signal outputted from the controller 150. The first switching unit 121 outputs the selected first multimedia signal to the first display unit 130. The second switching unit 122 is provided for selecting a second multimedia signal among the multimedia signals outputted from the multimedia sources 111 to 114 and based on the second control signal outputted from the controller 150. The second switching unit 122 outputs the selected second multimedia signal to the second display unit 140.

Accordingly, the first multimedia signal of the telematics terminal inside the vehicle is outputted to the first display unit and the second multimedia signal is outputted to the second display unit. Passengers seated in different seats, e.g., such as in the front seat and in the rear seat of the vehicle, can independently watch each different multimedia.

An exemplary method for outputting audio/video signals outputted from the multimedia outputting apparatus of the telematics terminal will be described with reference to FIGS. 3 to 5. In the following exemplary method, the first and second multimedia signals are first and second audio/video signals, e.g., containing both audio and video information.

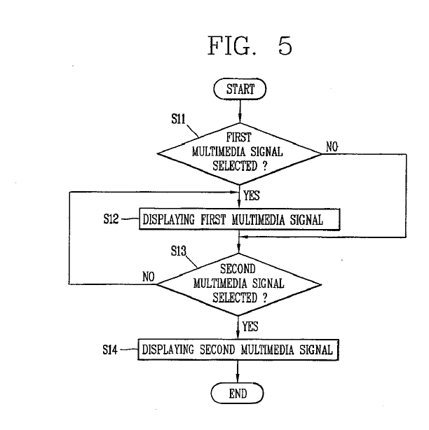

FIG. 5 is a flow chart of a process for outputting audio/video signal(s) from the telematics terminal. First, when a user(s) selects specific multimedia signals by using a select button (not shown) or a remote controller (not shown) for selecting a specific multimedia, the controller 150 outputs a first control signal for selecting a first multimedia signal and a second control signal for selecting a second multimedia signal according to the users' request(s). The controller outputs the first control signal to the first switching unit 121 and the second control signal to the second switching unit 122.

For example, when the TV tuner 112 is selected by the passenger in the front seat of the vehicle, the controller 150 outputs the first control signal for selecting the TV broadcast signal (the first multimedia signal) outputted from the TV tuner 112 to the first switching unit 121. When the CD/DVD processing unit 111 is selected by the passenger in a rear seat of the vehicle, the controller 150 outputs the second control signal for selecting the CD audio/video signal (the second multimedia signal) or the DVD audio/video signal (the second multimedia signal) outputted from the CD/DVD processing unit 111 to the second switching unit 122.

The first switching unit 121 selects the TV broadcast signal outputted from the TV tuner 112 based on the first control signal, and outputs the selected TV broadcast signal to the first display unit 130 (step S11). For example, the first display unit 130 is installed at the front side of the telematics terminal in the vehicle and displays a video signal contained in the TV broadcast signal selected by the user, e.g., the driver or the passenger next to the driver (step S12). A speaker installed at the first display unit 130 outputs an audio signal in synchronization with the video signal contained in the TV broadcast signal.

The second switching unit 122 selects a CD audio/video signal or a DVD audio/video signal outputted from the CD/DVD processing unit 111 based on the second control signal, and outputs the selected CD audio/video signal or the DVD audio/video signal to the second display unit 140 (step S13). The second display unit 140 is installed at the rear side of the front seat so that the passenger seated in the back seat of the vehicle can watch desired multimedia, and displays a video signal contained in the CD audio/video signal or the DVD audio/video signal selected by the user, e.g., the passenger in any rear seat, (step S14). In addition, a second speaker is installed at the second display unit 140 and outputs an audio signal in synchronization with the video signal contained in the CD audio/video signal or the DVD audio/video signal. The first and the second display units may be provided in numerous predetermined positions throughout the vehicle, such as one or more or both display units being disposed in rear seats, on window visors, or in front seats. The individual display units may include the first and the second speakers which include audio output(s) permitting the use of headphones for listening to audio content privately at the first and/or the second display units, and/or input ports for peripheral devices such as interactive gaming devices and controllers.

The first display unit 130 and the second display units may include any video display. However, LCDs (Liquid Crystal Displays) are used as the first display unit 130 and second display unit 140 in one embodiment. In addition, the first display unit 130 and/or the second display unit may include individual controllers so that content selection can occur locally at the display unit. For example, a display unit positioned in a rear, third row seat can be provided with a controller supporting content selection, such as multimedia content selection, and/or use as a game console and controller.

The foregoing apparatus and method for outputting multimedia provide one or more advantages. By outputting the first multimedia signal of the telematics terminal inside the vehicle to the first display unit and outputting the second multimedia signal of the telematics terminal to the second display unit, the passengers in separate seats, e.g., in the front seat and the back seat of the vehicle, can independently watch different multimedia.

The selective use of content for individual display units can be provided for a variety of multimedia modules producing or reproducing multimedia signals from a telematics terminal, or from stand-alone multimedia devices within a vehicle.

It should be understood that the above-described embodiments are not limited by any of the details of the foregoing description. Accordingly, other implementations are within the scope of the following claims.

1. An apparatus for outputting a signal from a telematics terminal inside a vehicle, the apparatus comprising:
the telematics terminal located inside of the vehicle and configured for outputting a plurality of audio and video signals;
a selection device configured for receiving audio and video signals outputted from the telematics terminal, and for selecting, from among the received audio and video signals, a first video signal, a first audio signal in synchronization with the first video signal, a second video signal and a second audio signal in synchronization with the second video signal;
a first multimedia output unit operatively connected with the telematics terminal at a front surface of the telematics terminal, the first multimedia output unit being configured for displaying the first video signal;
a second multimedia output unit operatively connected with the telematics terminal, the second multimedia output unit being configured for outputting the second video signal; and
a speaker for outputting the at least one first or the second audio signal.

2. The apparatus of claim 1, further comprising a connection for a multimedia device operatively connected to the second multimedia output device, wherein the connection to the multimedia device provides a port for interactive control of the second multimedia output device.

3. An apparatus for outputting multimedia from a telematics terminal comprising:
the telematics terminal;
a selection device operatively connected to the telematics terminal for selecting a first multimedia signal and a second multimedia signal from at least one multimedia source;
a first display unit for displaying an image based upon the first multimedia signal; and
a second display unit for displaying a separate image based upon the second multimedia signal.

4. The apparatus of claim 3, wherein the first and second multimedia signals each include audio and video signals.

5. The apparatus of claim 3, wherein the first and second display units each include a speaker.

6. The apparatus of claim 3, wherein the first and second display units comprise liquid crystal displays.

7. The apparatus of claim 3, wherein the at least one multimedia source is selected from the group consisting of an optical media processing unit, a TV tuner, a memory processing unit and an external signal processing unit.

8. The apparatus of claim 7, wherein the optical media processing unit comprises a CD/DVD processing unit for multimedia data recorded in a CD (Compact Disk) or a DVD (Digital Versatile Disk).

9. The apparatus of claim 7, wherein the TV tuner is configured for processing a TV broadcast signal from a channel selected by a user.

10. The apparatus of claim 7, wherein the memory processing unit is configured for processing multimedia data stored in a storage media.

11. The apparatus of claim 7, wherein the external signal processing unit is configured for processing multimedia data inputted to the selection device through an external line.

12. An apparatus for outputting multimedia comprising:
a telematics terminal within a vehicle;
a selection device for selecting first and second video signals from at least one multimedia source;
a first display unit operatively connected with the telematics terminal at a front surface of the telematics terminal for displaying an image based upon the first video signal; and
a second display unit operatively connected with the telematics terminal for displaying an image based upon the second video signal.

13. The apparatus of claim 12, wherein the selection device is configured for selecting a first audio signal synchronized with the first video signal and a second audio signal synchronized with the second video signal.

14. The apparatus of claim 12, wherein the first display unit includes a first speaker for outputting the first audio signal and the second display unit includes a second speaker for outputting the second audio signal.

15. The apparatus of claim 12, wherein the first and second display units comprise liquid crystal displays.

16. An apparatus for outputting multimedia from a telematics terminal inside a vehicle, the apparatus comprising:
the telematics terminal inside vehicle;
a selection device operatively connected with the telematics terminal, the selection device being configured for selecting a first dataset and a second dataset among multimedia data from an available storage media;
a first display unit within the vehicle for displaying the first dataset; and
a second display unit within the vehicle for displaying the second dataset.

17. The apparatus of claim 16, wherein the available storage media is selected from the group consisting of an optical media, data from a broadcasted channel selected by the user, multimedia data stored in a memory device and multimedia data communicated to the telematics terminal from an external location.

18. The apparatus of claim 16, wherein the selection device comprises:
a first switching unit for selecting the first dataset and outputting the selected first dataset to the first display unit; and
a second switching unit for selecting the second dataset and outputting the selected second dataset to the second display unit.

19. A method for outputting multimedia comprising:
selecting a first multimedia signal and a second multimedia signal from at least one multimedia source;
displaying an image based upon the first multimedia signal on a first display unit; and
displaying an image based upon the second multimedia signal on a second display unit.

20. The method of claim 19, wherein the first and the second multimedia signals each comprise audio and video signals.

21. The method of claim 19, wherein the first and second multimedia signals are selected from the group consisting of multimedia data recorded in an optical media, a TV broadcast signal of a channel selected by a user, multimedia data stored in a memory device, and multimedia data communicated from an external source.

22. The method of claim 19, wherein the first and second display units comprise liquid crystal displays.

23. A method for outputting multimedia from a telematics terminal within a vehicle, the method comprising:
selecting first data and second data, wherein the first data and the second data are each selected from the group consisting of multimedia data recorded in an optical media and selected by a user, TV broadcast data from a channel selected by the user, multimedia data stored in a memory and multimedia data communicated from an external source;
displaying the first data on a first display unit operatively connected to the telematics terminal; and
displaying second data on a second display unit operatively connected to the telematics terminal.

24. The method of claim 23, wherein the first display unit is installed at a front surface of the telematics terminal and the second display unit is installed at a predetermined position inside the vehicle.

25. The method of claim 23, further comprising inputting a multimedia signal to the second display unit from a multimedia device operatively connected to the second display unit.
